(19) United States
(12) Patent Application Publication
(10) Pub. No.: US 2013/0097634 A1
(43) Pub. Date: Apr. 18, 2013

(54) SYSTEMS AND METHODS FOR REAL-TIME ADVERTISEMENT SELECTION AND INSERTION

(71) Applicants: Luojun JIN, Waterloo (CA); Vinay KUMAR, Brampton (CA)

(72) Inventors: Luojun JIN, Waterloo (CA); Vinay KUMAR, Brampton (CA)

(73) Assignee: ROGERS COMMUNICATIONS INC., Toronto (CA)

(21) Appl. No.: 13/272,258

(22) Filed: Oct. 13, 2011

(51) Int. Cl. H04N 21/458

(52) U.S. Cl. 725/34

(57) ABSTRACT

Methods and devices for implementing real-time advertisement customization and selection. A video program has associated avail metadata, separate from the video program itself, and which is generated to define the avails for the video program. The avail metadata may contain fields specifying the duration, insertion point and type of each avail, and may also specify characteristics of the video program. An avail metadata encoder is configured to customize the avail metadata based on a request to view or play the video program. The customization may be specific to a client device and may reflect various characteristics, including details of the client device, an associated subscriber profile, geographic information, etc. Advertisements are then dynamically selected using the customized avail metadata and links to the advertisements are placed in the customized avail metadata.

### FIELD

The present application relates generally to advertisement selection and insertion and, more particular, to devices, systems and methods for real-time insertion of contextually suitable advertisements in media.

### BACKGROUND

Traditional broadcast television video features advertisements spliced into original content/programming The complete video with advertisements is then distributed to different locations for playback over-the-air, over a cable television system, or over a satellite television system. In some instances, a local television content provider/station or a local carrier, such as a cable operator, may be permitted under contract to replace or overwrite some of the spliced advertising with local advertisements aimed specifically at the local audience.

This model has significant limitations in light of developments in the industry. The audience watches the same advertisements irrespective of their personal or household characteristics and preference. The same advertisements are generally shown when a program is available in two different geographic locations, such as when a cable television customer from one part of the country watches a local channel from another part of the country. Advertisements are the same irrespective of whether the viewer is watching the video on a large television, a tablet, a PC monitor, or a mobile handheld device. Different transcoding may be applied to the advertisements before being presented to those various devices, but the original pre-transcoding advertisement is identical. Programs that are time-shifted or have been stored for playback, such as on a PVR device (local or network), may contain out-of-date advertisements.

### BRIEF DESCRIPTION OF THE DRAWINGS

Reference will now be made, by way of example, to the accompanying drawings which show example embodiments of the present application, and in which:

FIG. 1 shows an example of a generalized media system;

FIG. 2 shows, in flowchart form, one example method for customizing avail metadata;

FIG. 3 shows, in flowchart form, an example method for selecting advertisements for insertion into a video program;

FIG. 4 diagrammatically shows one embodiment of a system and process for a first example use-case;

FIG. 5 diagrammatically shows another embodiment of a system and process for a second example use-case;

FIG. 6 diagrammatically shows a further embodiment of a system and process for a third example use-case; and

FIG. 7 shows, in flowchart form, one example method of generating basic avail metadata.

Similar reference numerals may have been used in different figures to denote similar components.

### DESCRIPTION OF EXAMPLE EMBODIMENTS

In one aspect, the present application describes method for real-time advertisement insertion. The method includes receiving, at an avail metadata encoder, a request associated with a client device, wherein the request identifies a video. The avail metadata encoder, in response to the request, then obtains avail metadata associated with the video, wherein the avail metadata includes information regarding the video and avails defined for the video, and customizes the avail metadata by adding information to the avail metadata regarding the client device to produce customized avail metadata. The method also includes selecting advertisements from a plurality of available advertisements based upon the customized avail metadata and inserting links to the selected advertisements into the customized avail metadata; requesting and receiving the selected advertisements from an ad asset server using the links; and splicing the selected advertisements into the video during play of the video.

In yet another aspect, the present application describes a system for real-time advertisement insertion. The system includes an avail metadata encoder having a memory, a processor, and an application executable by the processor that configures the processor to receive a request associated with a client device. The request identifies a video. The processor is configured to obtain avail metadata associated with the video, wherein the avail metadata includes information regarding the video and avails defined for the video, and customize the avail metadata by adding information to the avail metadata regarding the client device to produce customized avail metadata. The system includes an advertising management and decision server configured to select advertisements from a plurality of available advertisements based upon the customized avail metadata and to insert links to the selected advertisements into the customized avail metadata, whereby selected advertisements are obtained from an ad asset server using the links, and the selected advertisements inserted into the video during play of the video.

Other aspects and features of the present application will be understood by those of ordinary skill in the art from a review of the following description of examples in conjunction with the accompanying figures.

In the present application, the term “avail” is used to refer to an advertising opportunity. In many instances, an “avail” may refer to a particular timeslot in a video for advertisement. For example, an avail may be a 30-second spot with a defined entry point and exit point in the video. In other instances, an “avail” may refer to less linear advertisement opportunity, or an advertisement opportunity in interactive media. Examples may include banner ads, overlays, skins, etc.

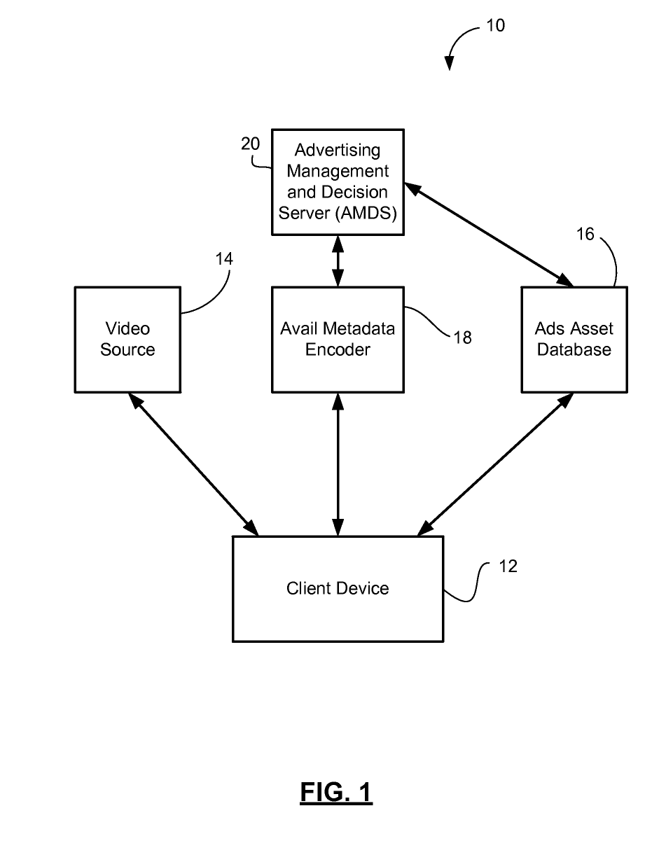

Reference is first made to FIG. 1, which shows a generalized media system 10. The system 10 includes a client device 12, a video source 14 and an ad asset database 16. The system 10 further includes an avail metadata encoder 18 and an ads management & decision server (AMDS) 20.

The client device 12 may be a set-top box or satellite receiver and associated television or video monitor. In other embodiments, the client device 12 may be a personal computer configured for communication over a wireless or wired connection via an Internet Service Provider (ISP). In yet other embodiments, the client device 12 may be a mobile device configured for wireless communication, such as mobile phone, smart phone, tablet, laptop, or other such device. In yet further embodiments, the client device 12 may be a video game system or other console configured to communicate over a wired or wireless connection to the Internet and configured to output video to a television or other display device. Other possible client devices 12 will be appreciated by those skilled in the art having regard to the following description.

The video source 14 may be a head-end system in a service provider domain, such as a cable operator, satellite television provider, etc. In some cases, the video source 14 may be a video server in the VoD/CoD system, an internet video server, network PVR, or any other such source for video content. The video source 14 streams video content to the client device 12. In some cases, the video source 14 may be a broadcast service, providing streamed broadcast video to a plurality of client devices 12 (only one shown). In some cases, the video source 14 may be a point-to-point service, providing a requested video to a specific client device 12.

The ad asset database 16 stores advertisements, which may include ad assets for video spots, skins, banner ads, or other advertising media types.

The video source 14 and ad asset database 16 may be located within a service provider network in some embodiments. For example, the video source 14 and ad asset database 16 may be located within the cable television network of a cable television provider. In another example, the video source 14 and ad asset database 16 may be located within the wireless network of a wireless carrier. In some embodiments, the video source 14 and/or the ad asset database 16 may be located outside the service provider network. In some embodiments the video source 14 and/or ad asset database 16 are in arbitrary locations and are accessible via the Internet or another public data network.

The client device 12 is configured to communicate over wired or wireless networks, or both. In particular the client device 12 is configured to receive video (digital, analog, compressed, streamed, etc.) over a communications channel from the video source 14. In some instances, the client device 12 is configured to request a particular video from the video source 14 or an intermediate server that instructs the video source 14 to provide the client device 12 with the video content. Likewise, the client device 12 is configured to receive ad content from the ad asset database 16 over a communications channel. The same communications channel operating over the same connection (for example, an IP connection to an ISP) may be used to receive communications from both the video source 14 and the ad asset database 16 in some implementations.

The avail metadata encoder 18 is adapted to locate or obtain avail metadata associated with video content from the video source 14, and to update or modify that avail metadata to personalize or customize the avail metadata based upon user or client device profile and/or current viewing context. The updated avail metadata is provided to the AMDS 20 for identification and selection of specific advertisements to be associated with viewing of the video content by the client device 12.

The avail metadata encoder 18 and AMDS 20 may be implemented in a common server or service. In some instances, the AMDS 20 may also or alternatively be integrated with the ad asset database 16 in some implementations. In yet other implementations, part of or the entire AMDS 20 may be located within the client device 12 itself.

The AMDS 20 may, in some embodiments, further modify the updated avail metadata to insert specific identifiers for the selected advertisements and other avail data to enable a splicer to select and insert the correct advertisements into the video content during playback on the client device 12. In some instances the splicing may occur at the client device 12. In other instances, the splicing may occur within the network, for example at the video source 14, or an intermediate server or service, before the consolidated video content with advertisements is transmitted to the client device 12 for viewing.

Advantageously, the avail metadata is data separate from the video content itself. Accordingly, the avail metadata may be customized to particular viewers, client devices, time-and-place contexts, etc., without requiring any modification of the original video content. Suitable advertisements that are directed to the characteristics of a particular situation (as indicated by the customized avail metadata) are then selected and inserted during viewing of the video content. This provides significant flexibility to modify and adapt advertisement insertion to a specific time, place, viewer, client device, etc. For example, advertisements may be tailored to the preferences or viewing history of a particular viewer. Advertisements may be tailored to the type and capabilities of the client device 12. Advertisements may be tailored such that a time-shifted video uses current advertisements, irrespective of how long ago the video content was created and stored within the network. Advertisements may be selected to be geographically appropriate to the location of the client device. In fact, the same viewer that begins the viewing of a video program (e.g. a movie) in a first location may pause the program and restart viewing later in another location (e.g. another city), and the advertisements played during the later viewing may be different than those that would otherwise have been played had the viewer continued viewing the program in the first location.

The separation of the avail information from the video content enables this flexibility. Accordingly, the avail information is provided in a separate data source to describe the avail referred to herein as “avail metadata”. The form and format of the avail metadata may depend on the specific implementation. In some instances, the avail metadata may be generated and stored in a database. In some instances, the avail metadata may be generated in HTML, XML, XHTML, RTF, or any other suitable language and format. Accordingly the avail metadata may be embodied in a document or file, in a database record or a record in another data structure, in fields embedded in a communication protocol or structure, or other formats.

The avail metadata may include data identifying the associated video, data identifying or classifying the content of the video, data identifying the client device and its capabilities, data profiling the user, data regarding the user's viewing history, policy data specifying lifecycle or restrictions regarding particular avails, avail details including type and timing information, and other data.

In one non-limiting example, the avail metadata may include the following data types or fields:

| Fields | Definition | |
|---|---|---|
| PID | Metadata identifier for each avail | |
| Video title | The title of the video program associated with the avails | |
| Time | Maps to the unit presentation time stamp of the video program. May | |
| stamp | include several sub fields such as: In point (point in the video stream | |
| | suitable for ads insertion); Out point (point in the video stream suitable | |
| | for ads exit); and length/duration of the avail. | |
| Service | Defined by advertiser and/or service provider. Example policy settings | |
| policy | include: | |
| | | Unchangeable, the original placement related to this avails |
| | | cannot be modified. |
| | | Original Advertiser only, only can be used for the ads from |
| | | original advertisers. |
| | | Changeable, could be used by service providers. |
| Contextual | Indicates the type of the video content being played (may be used for | |
| tag | contextual ads and program recommendation purposes) | |
| Ads type | Defines the type of ads for the avail. Examples include: | |
| | | All, all formats are effected |
| | | Overlay only |
| | | Skin only |
| | | Companion only |
| | | Banner only |
| | | other |

| | |
|---|---|
| Ads asset URI | Defines the location of the ads asset database for client device |
| User profile | Provides a user/subscriber's basic information such as gender, age, etc.; |
| | may also include classification data like income bracket, profession, |
| | etc. |
| User | Provides a list of viewing history, by title, category or other identifiers; |
| history | may include video and advertisements |
| Location | Specifies user's current location. |
| Life cycle | Specifies the lifecycle of ads assets for this avail, example, the |
| | effective start date and end date etc. |

When initially produced, the avail metadata may contain only basic avail metadata. For example, it may contain data regarding the program and/or broadcaster. It may contain information regarding particular contextual elements of the video, such as indicators of particular brands, or categories of products or advertisements, sometimes together with timing indicators highlighting when in the program those brands appear. The basic avail metadata may also specify avail timing or type information. Policy information may also be included in the basic avail metadata, such as whether particular ads may be replaced or not under the content provider's policy. Some basic avail metadata may be available based on ANSI/SCTE 30 and 35 standards for digital program insertion splicing.

The precise information contained in the basic avail metadata may vary depending on the program and the specific application. In some cases, the basic avail metadata populated in an avail metadata manually. In other cases, the basic avail metadata may be at least partially generated automatically. For example, in one embodiment, basic avail metadata may be generated by analyzing the program and automatically determining suitable points for advertisement insertion. Those points may be specified as avails. One example process for automatically identifying suitable avails using a scene-change analysis is further described below.

The basic avail metadata may be stored with and co-located with the video program in the video store 14 in some embodiments. In other embodiments, the metadata may be located in a separate database, as a file, record, or other entry or entries. A request for a particular video program may trigger a search of the separate metadata database to locate the corresponding basic avail metadata. The metadata contains a video identifier from which the avail metadata encoder 18 or other element of the system 10 may locate and retrieve the correct metadata associated with the requested video program.

The avail metadata encoder 18 performs a personalization or customization process to tailor the avail metadata to the specific client device 12 that has requested play of the video program.

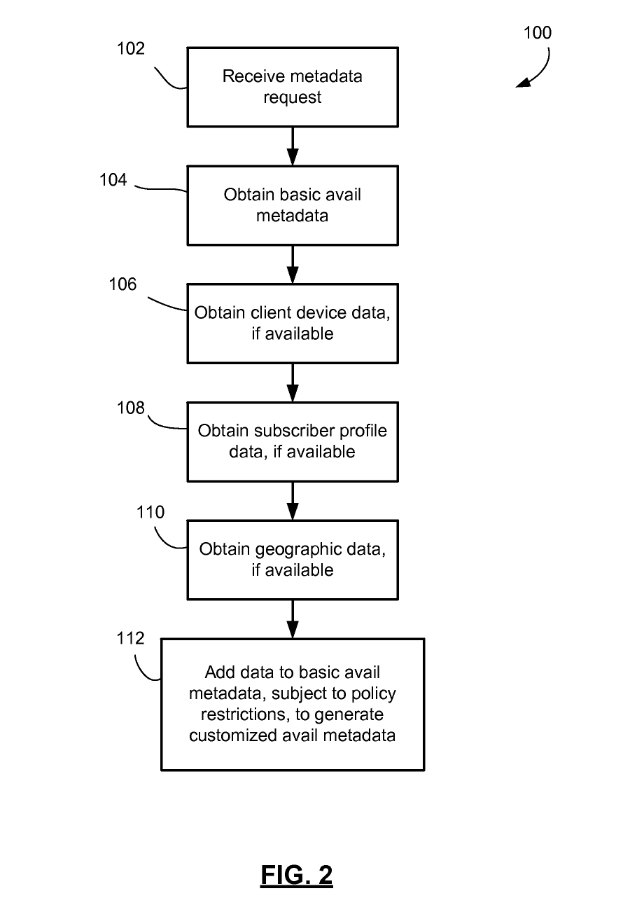

FIG. 2 shows, in flowchart form, one example method 100 for customizing avail metadata. The method 100, in this embodiment, is implemented by the avail metadata encoder 18. The method 100 begins in operation 102 with receipt of the metadata request. The metadata request may be received by the avail metadata encoder 18 from the client device 12, in some embodiments. For example, the client device 12 may send a request for a particular video to the encoder, and based upon this request the encoder identifies the corresponding avail metadata for that video and passes the request for the video to an associated video asset database for retrieval or streaming of the video to the client device. In another example, the client device 12 may send a request for a video directly to a video asset database and may send a separate metadata request to the encoder 18. The metadata request identifies the requested video with which the metadata request is associated. In yet another example, the client device 12 may send a video request to a video asset database (or proxy) and the video asset database may generate and send a metadata request to the encoder. In yet a further example, the client device 12 may have the video stored locally and may receive a playback request from a user, upon which the client device 12 generates and sends a metadata request to the encoder 18. In this latter example, the basic avail metadata is likely already available on the client device 12 since the client device 12 has previously requested and obtained a copy of the video program. In that instance, the metadata request send to the encoder may be for an update to the customization, rather than a new request for avail metadata.

In operation 104, in response to the receipt of the metadata request, the encoder 18 obtains the basic avail metadata. The encoder may obtain the basic avail metadata from a local database or other storage system containing basic avail metadata. The encoder may obtain the basic avail metadata from a remote database or other storage system configured to accept queries for particular basic avail metadata from avail metadata encoder. In some embodiments, the basic avail metadata may be stored with the video program in a video asset database, i.e. video source 14. In that case, the avail metadata encoder 18 may obtain the basic avail metadata from the video source 14. The video source 14 may automatically transmit the basic avail metadata associated with a requested video program to the avail metadata encoder 18 when the video source 14 receives a video playback request from the client device 12. In such an instance, operations 102 and 104 are combined in the operation of receiving the basic avail metadata at the encoder from the video source, together with an identifier for the client device or user that sent the video playback request to the video source 14.

Operation 106 involves the encoder 18 obtaining client device information, if available. As noted above, this information may be contained within the metadata request or other messaging received by the encoder. The client device information may indicate the category of client device, e.g. television, personal computer, mobile handheld device, tablet, etc., and/or specific characteristics of the device, such as screen size, resolution, etc.

Operation 108 involves the encoder 18 obtaining subscriber profile data, if available. For example, the avail metadata encoder 18 may have access to a subscribe profile database containing data regarding individual subscribers. The metadata request may specify the identity of the specific subscriber, or the client device may be associated with a specific subscriber. If so, the subscriber profile database may contain details regarding the subscriber's preferences and profile. For instance, the database may contain data regarding the subscriber's viewing history, or data gleaned from the subscriber's viewing history, like a preference for particular genre's of programming or particular products or services. The subscriber's demographic details may be indicated in the profile data, such as the subscriber's age category, income category, or other such personal characteristics that may be later used to tailor advertising to the particular subscriber. In some cases, the subscriber profile data may be obtained from third party sites, such as social media networking sites like Google+™, Facebook™, and others, subject to the privacy restrictions put in place by the subscriber.

In operation 110, the encoder 18 may obtain geographic data regarding the client device. The geographic data may, in some cases, be based on stored information regarding the specific client device in the case of an immobile device, such as based upon a subscriber billing address. The geographic data may be obtained based on the client device IP address, geographic location data supplied by the client device, such as through GPS, visitor location register (VLR), etc.

In operation 112, the data obtained by the avail metadata encoder 18 is then used to customize the basic avail metadata by populating various fields of the metadata form to generate customized avail metadata. The customization process may be subject to certain policy restrictions, such as privacy and security policies that may change from time-to-time. In some cases, particular subscribers may have individualized policies governing the extent to which their personal data may be used to customize the avail metadata.

In one alternative embodiment, the method 100 may be at least partly implemented by the client device 12. For example, the encoder 18 may send the client device 12 the basic avail metadata, and the client device 12 may be configured to populate various fields of the metadata so as to customize the metadata to the client device and/or subscriber. The client device 12 then returns the customized avail metadata to the encoder 18, for the use in the ads decision and selection process described below. The encoder 18 may still, in this embodiment, perform some customization since the client device 12 may not have information regarding the subscriber's viewing history and other data not specific to that particular device.

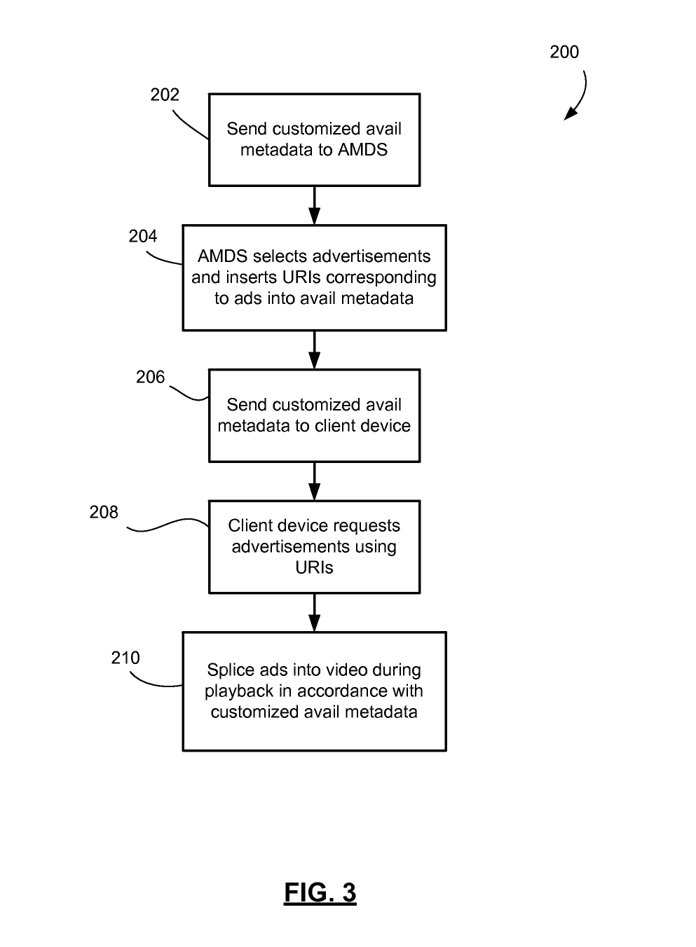

Reference is now made to FIG. 3, which shows, in flowchart form, an example method 200 for selecting advertisements for insertion into a video program.

The method 200 includes an operation 202 of sending customized avail metadata to an ads management and decision server (i. e. an AMDS 20). The customized avail metadata may be generated using a process such as that described above in connection with FIG. 2. The customized avail metadata may be sent to the AMDS 20 by the encoder 18 in some embodiments.

In operation 204, the AMDS 20 selects ad assets based upon the customized avail metadata. It will be appreciated that there are a wide variety of algorithms and techniques for selecting suitable ad assets based upon the customized avail metadata. Factors that influence the ad selection may include geographic location, client device characteristics, subscriber profile, service policy, avail type, and others. These factors may be used to filter ads available for insertion to identify a subset of candidate ads. Various policies and/or decision logic may be applied to select a particular ad for each avail.

The AMDS inserts a URI for each selected ad into the customized avail metadata. The URI for a selected ad is inserted in such a manner that it is specific to a given avail. For example, each avail defined in the metadata may have a field associated with it that contains the URI of the selected ad asset. The URI (or in some cases, multiple URIs) points to the selected ad asset so that the client device or other splicing mechanism can retrieve the selected ad asset.

In operation 206, the customized avail metadata containing the selected ad asset URIs is then provided to the client device (or, in some embodiments, an intermediate splicer within the network configured to combine the ad assets with the video program). The client device (or intermediate splicer) requests the selected ad assets using the URIs from the customized avail metadata in operation 208.

In operation 210, the client device (or intermediate splicer) inserts the ad assets into the video program during playback (or streaming, as the case may be). The nature of the insertion depends on the type of avail associated with the ad asset. For example, banner ads are displayed for a defined period of time in a banner location on the client device screen whilst the video program continues to play in its defined window. Linear ads are inserted at defined insertion points in the video program, which in some embodiments means the playback of the video program is paused or halted for the duration of the linearly inserted ad, and the video program is then resumed.

It will be appreciated that the encoder 18 and AMDS 20 may be logically separate but implemented on a common server or server farm in some embodiments.

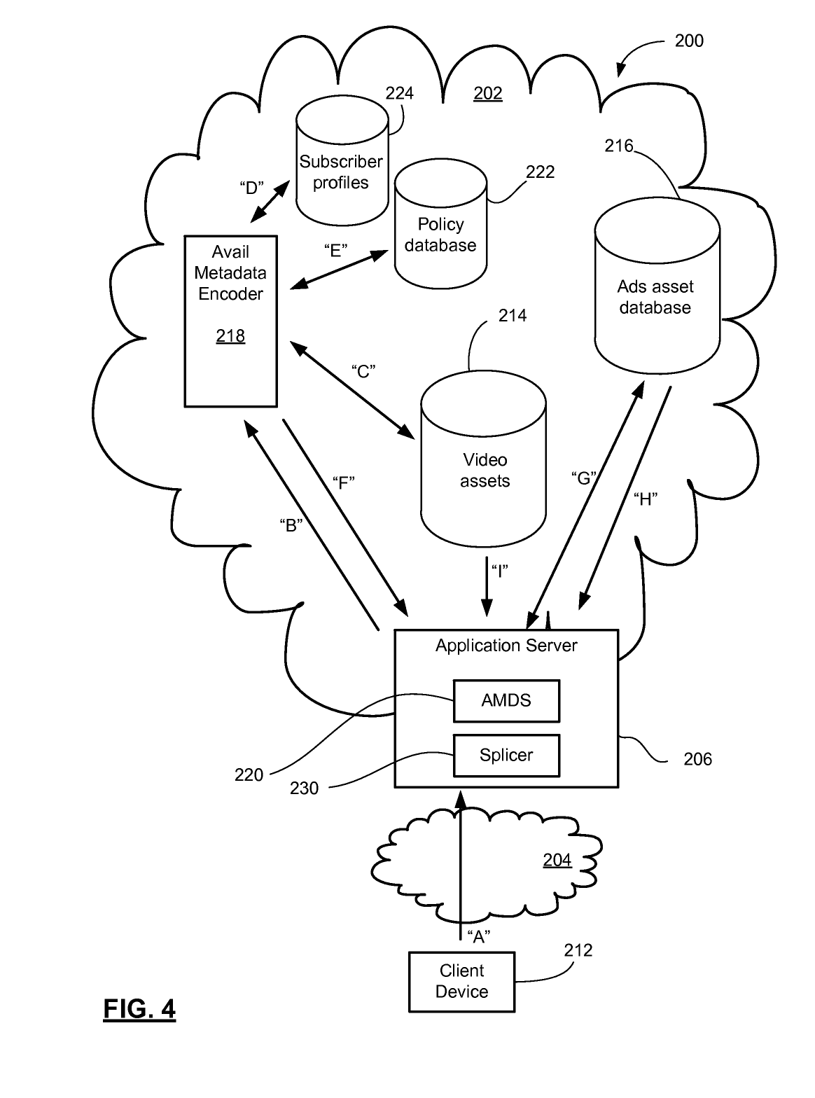

Reference is now made to FIG. 4, which diagrammatically illustrates one embodiment of a system 200 and process for a first example use-case.

The system 200 shown in FIG. 4 is one in which a client device 212 accesses a provider network 202 through an access network 204. The access network 204 may be, for example, a mobile wireless network, a cable IP network, or other type of access technology. The client device 212 may include a set-top box (STB), television, mobile device, personal computer, etc. The provider network 202 may include a network of databases and servers operated by a video provider, such as a cable television carrier, telephone carrier, television broadcaster, or other such entity. The access network 204 may be operated by the same entity as the provider network 202 in some embodiments, although this is not necessary.

The client device 212 is configured to connect to an application server 206 within the provider network 202. Access to the application server 206 may be restricted to subscribers in some embodiments and various authentication and verification processes may be implemented to verify that the client device 212 has the requisite permissions to access the application server 206.

In this example embodiment, the provider network 202 further includes an avail metadata encoder 218, a subscriber profile database 224, a policy database 222, an ads asset database 216, and a video asset database 214. The video asset database 214 contains a library or catalog of videos available for viewing by subscribers. In some instances, the video asset database 214 may also store the basic avail metadata associated with each video program in the video asset database 214.

The application server 206 includes the AMDS 220 and a splicer 230. It receives a request (denoted “A”) from the client device 212 for a particular video from the video asset database 214. In a broadcast embodiment, the request may be generated by the client device 212 as a result of the client device selecting (tuning) a particular video stream. In such an embodiment, the client device 212 is not strictly requesting a discreet video program, but is tuning into a video channel being broadcast, for example, within the access network 204. In a unicast or multicast example, the client request is for a particular video program stored in the video asset database 214 and available on demand (e.g. VOD) or available for a scheduled multi-cast event (e.g. pay-per-view).

In response to the client request, the application server 206 requests avail metadata (denoted “B”) for the requested video from the avail metadata encoder 218. The avail metadata encoder 218 obtains basic avail metadata associated with the requested video. In some cases, the avail metadata encoder 218 may store basic avail metadata in local memory. In some cases, the avail metadata encoder 218 may dynamically generate the basic avail metadata, or may use a standard basic avail metadata template as the basis for the basic avail metadata if the requested video does not have associated avail metadata. In some cases, the avail metadata encoder 218 may obtain the basic avail metadata associated with the requested video from the video asset database 214, as indicated by reference “C”.

The avail metadata encoder 218 is configured to customize the basic avail metadata, for example using information from the policy database 222 as indicated by “E”, the subscriber profile database 224 as indicated by “D”, and/or the client device 212 itself. In some instances, the request for the video program from the client device 212 contains client device information which the application server 206 passes along to the avail metadata encoder 218. In some cases, the avail metadata encoder 218 may query the client device 212 for information and may receive information regarding the client device and/or the user in response.

Once the avail metadata encoder 218 has customized the avail metadata, the customized avail metadata is provided to the application server 206 as indicated by “F”. The AMDS 220 selects ads from the ads asset database 216 based upon the customized avail metadata, as indicated by “G”.

In this embodiment, the splicer 230 is present in the application server 206. Accordingly, the application server 206 is configured to splice (or otherwise combine) the selected ad assets with the video program. Although the term “splicer” is used, it will be understood that the operations are not limited to splicing in the conventional linear sense.

The AMDS 220 in some embodiments modifies the customized avail metadata to insert URIs for the selected ad assets. In some captive network embodiments, such as shown in FIG. 4, where the ads, videos and splicing are all contained within the provider network 202, the AMDS 220 may forego inserting URIs and may simply obtain the ad assets from the ads asset database 216, as indicated by “H”. The splicer 230 may then insert/splice ads into the video stream (denoted “I”) during streaming of the video program to the client device 212 based on the timing and selection data contained in the customized avail metadata. In other embodiments, the AMDS 220 may insert the URIs and the splicer 230 may perform the task of requesting the ad assets from the ads asset database 216.

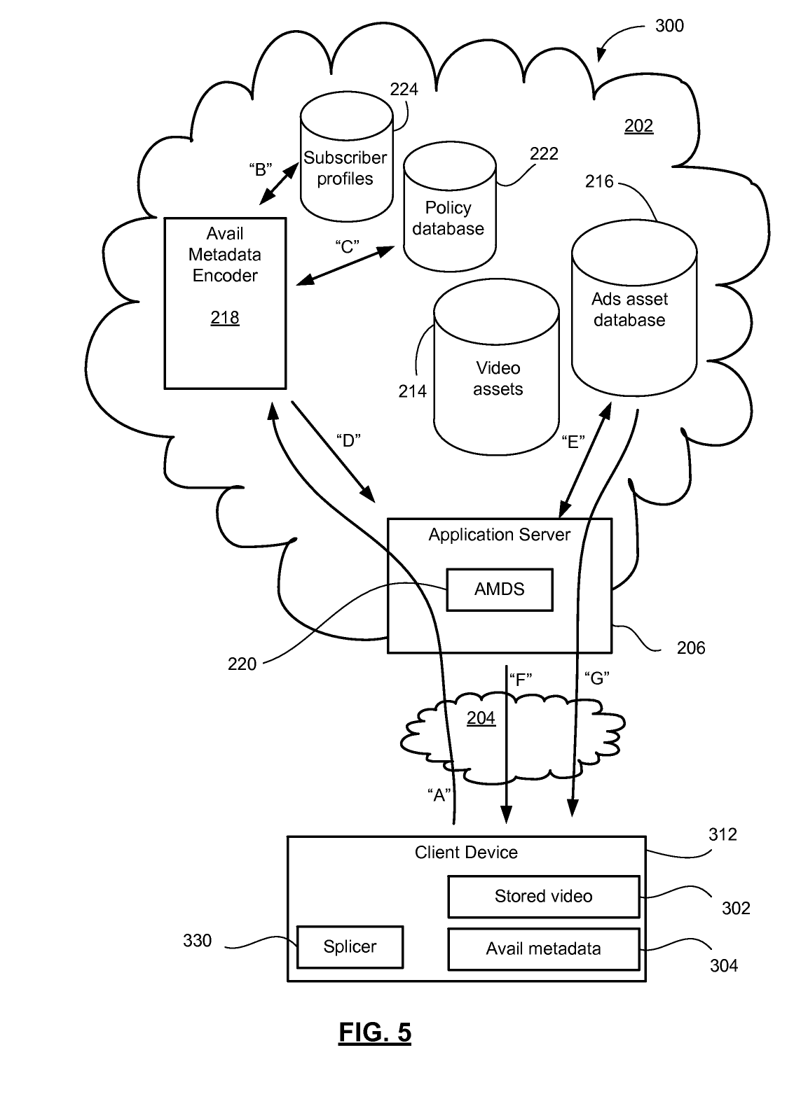

Reference is now made to FIG. 5, which diagrammatically illustrates another embodiment of a system 300 and process for a second example use-case.

In this example embodiment, the client device 312 contains a splicer 330 and has a memory containing stored video 302 and associated avail metadata 304. The stored video 302 may include, for example, video content previously recorded or downloaded. In this respect, the client device 312 may be a personal video recorder (PVR), personal computer, mobile handheld device, or other computing device capable of storing and replaying video content.

This example embodiment again features the provider network 202 containing the avail metadata encoder 218, subscriber profile database 224 and policy database 222. The application server 206 includes the AMDS 220, and the provider network 202 contains the ads asset database 216.

When the client device 312 receives a video playback request (for example through the user interface) with respect to one of the stored videos 302, it generates and sends an avail update request (denoted “A”) to the application server 206. The avail update request may, in some embodiments, include a copy of the associated avail metadata 304 stored on the client device 312 and an indication that the client device 312 wishes to update the metadata.

The request is forwarded to the avail metadata encoder 218, which gathers subscriber profile data “B” and policy information “C” and customizes the avail metadata accordingly. Because the metadata was previously available on the client device, it may already reflect policy and subscriber profile data, so the avail metadata encoder 218 may simply confirm that the information is up-to-date. Changes may have occurred in time/date, geographic location, user identity, usage history, service policies, etc., any one of which can result in the avail metadata encoder adding or changing information within the metadata to produce the customized avail metadata. The customized avail metadata is then passed to the AMDS 220, as indicated by “D”.

The AMDS 220 then selects suitable ads for the avails defined in the customized avail metadata, as indicated by “E”. The AMDS 220 may insert URIs for the selected ads into the customized avail metadata and then return it to the client device 312, as indicated by “F”. The client device 312 then obtains the ads from the ads asset database 216, as indicated by “G”, based upon the URIs in the customized avail metadata. The splicer 330 inserts the ads in the form and manner specified in the avail metadata.

It will be appreciated that the playback of the video may begin other than at the beginning; for example, if a user chooses to watch the remainder of a video program that was previously partly viewed. Accordingly, the client device 312 can prioritize its download request for ads from the ads asset database 216 based on the current viewing point in the video and the customized ads avail metadata information regarding the timing of upcoming ads in the video program. Thus, the client device 312 may minimize delays that result from awaiting ad download or streaming.

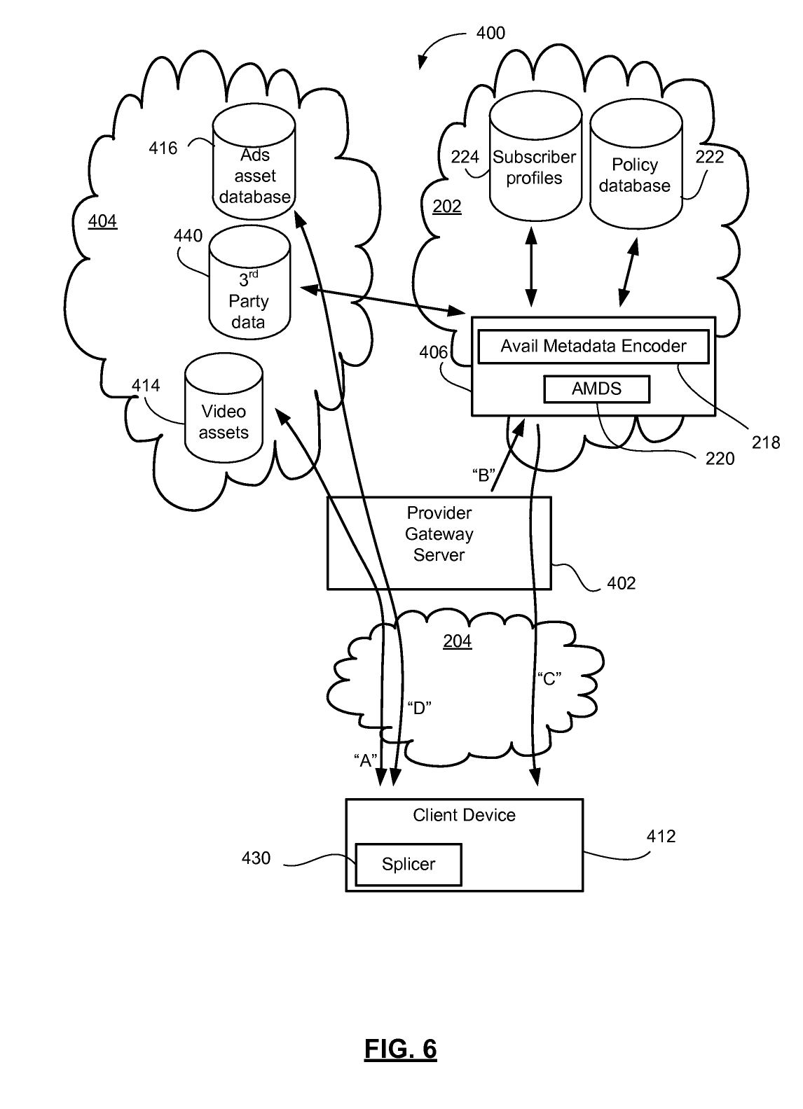

Reference is now made to FIG. 6, which shows yet a further example embodiment of a system 400 and process for a third example use-case.

In this example, the video programs and ads assets are not necessarily captive within the provider network. In this example, the system 400 includes a provider gateway server 402 accessed by a client device 412 through the access network 204. The provider gateway server 402 may act like a proxy server in some respects.

The client device 412 may access third party web sites or other resources within the broader Internet 404, including a video source 414. A request (denoted “A”) by the client device 412 to download or stream a video program from the video source 414 may trigger an avail request (denoted “B”) from the provider gateway server 402 to an avail server 406 within the provider network 202. The avail request may also be generated by the client device 412 itself and addressed to the avail server 406. The avail request identifies the video program with as much specificity as possible. In some cases, the avail request may include a link or other URI or identifier for the video source 414 and/or an associated source for avail metadata.

The avail server 406 in this example embodiment includes the avail metadata encoder 218 and the AMDS 220. The avail server 406 has access to the policy database 222 and subscriber profile database 224. In response to the avail request, the avail metadata encoder 218 generates or obtains basic avail metadata. If basic avail metadata exists in association with the requested video program, the avail metadata encoder 218 may retrieve that metadata. If not, then the avail metadata encoder 218 may generate new basic avail metadata and may associate it with the video program. The avail metadata encoder 218 may generate the metadata using a template and/or logic rules. Factors in determining the avails to define with regard to the video program may include the length of the program, pre-existing service policies, the source of the program, etc.

The avail metadata encoder 218 customizes the basic avail metadata in reliance upon, for example, subscriber profile information from the subscriber profile database 224 and policy information from the policy database 222. It may also customize the metadata based upon information regarding the client device 412 and/or user. In this example, the avail metadata encoder 218 may further obtain subscriber information from third-party information sources (generally denoted 440), subject to privacy and access restrictions in place at the third-party information sources 440 or imposed by the provider security and privacy policies. Example third-party information sources include social networking sites, like Facebook™ and others. The customized avail metadata is then provided to the AMDS 220 for use in selecting ad assets.

In this example embodiment, the ads asset database 416 is a third-party database (or databases) accessible to the AMDS 220 via the Internet 404. The AMDS 220 may gather ad availability information (on demand or periodically) and may maintain a repository locally of ad information from which it may select suitable ads. In any event, the AMDS 220 selects ads for the customized avail metadata and inserts URIs to the ads into the metadata. The customized avail metadata is then sent to the client device 412 as indicated by

The client device 412 obtains the ads from the third-party ads asset database 416, as indicated by “D”. A splicer 430 within the client device 412 inserts the ads into the video program obtained by the client device 412 from the video source 414.

It will be appreciated that the foregoing use-cases are examples only. Many variations and modifications may be made without significantly departing from the characteristics of the systems and processes.

As noted above, the avail metadata encoder does not always have basic avail data for a video program available to it. In some cases, the video program may not have associated avails pre-defined. In other cases, the avails are not specified in metadata or are unavailable to the avail metadata encoder. In such instances, the avail metadata encoder may be configured to generate basic avail metadata by determining avails for the video program and generating basic avail metadata defining those determined avails. One example mechanism for determining avails is through scene change detection.

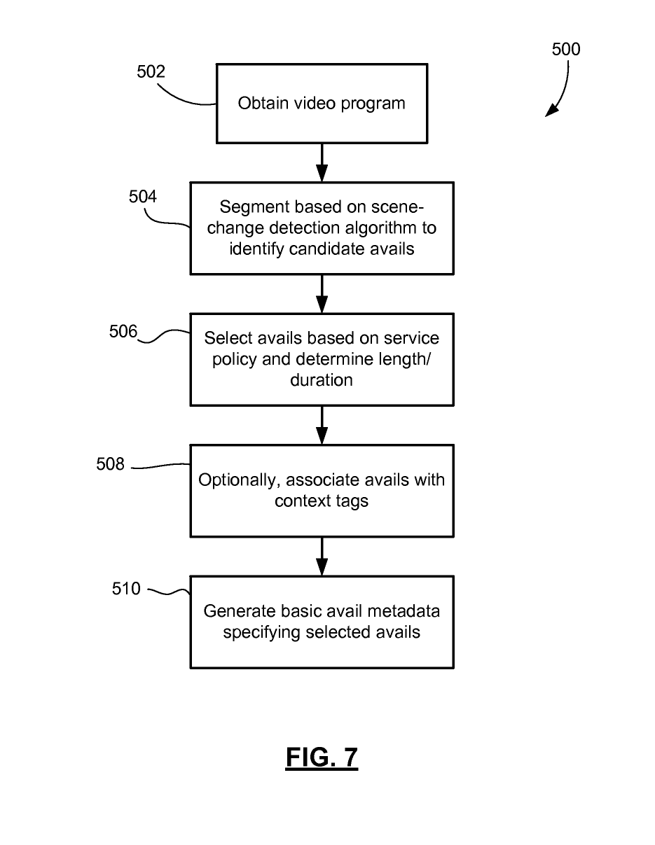

Reference is now made to FIG. 7, which shows, in flowchart form, one example method 500 of generating basic avail metadata. The method 500 begins with receipt of a copy of the video program by the avail metadata encoder in operation 502. In operation 504, the avail metadata encoder segments the video program using a scene-change detection algorithm. Many scene-change detection algorithms may be applicable. Selection of a suitable algorithm, or the configuration of the algorithm, may depend on the format of the video program. For example, a scene-change algorithm optimized for MPEG-2 video may not be the most suitable for use with video in another format. The avail metadata encoder may be configured to select from between more than one scene-change detection algorithm based on the video format, or may configure the settings of the algorithm based on the video format. In addition, the selection of a scene-change detection algorithm may be selected or may be configurable based upon the type of video. For example, a scene-change detection algorithm may use different settings when attempting to detect scene changes in a sports program versus a drama.

The segmentation of the video produces a set of candidate avails. The candidate avails may have “scores” or probabilities based on the degree of confidence the scene-change algorithm has in having detected a scene change at that point. In operation 506, the candidate avails are filtered to a set of selected avails. The filtering may be based on a number of factors. In particular, the avail metadata encoder may apply a service policy defining the minimum and maximum number of avails, their overall duration, their minimum and maximum individual duration, and avail formats permitted (e.g. banner, linear, overlays, etc.). The spacing of avails may be an additional factor in identifying the selected avails. For example, logic rules may tends to disperse the avails somewhat evenly over the duration of the program, rather than permitting them to be grouped heavily into one temporal portion of the program.

Having identifier the selected avails and their respective durations in operation 506, then in operation 508 the avail metadata encoder may optionally associate context tags with individual avails. The context tags may identify subject, products, themes or other contextual information regarding the content of the video program before or near the avail which may subsequently be used by the AMDS to select a contextually-suitable ad for the avail. The context information may be obtained from third party sources associated with the video program. The video program itself may have metadata providing contextual data regarding its content.

In operation 510, the avail metadata encoder produces the basic avail metadata having defined therein the selected avails and their respective characteristics.

In the foregoing description, the avail metadata encoder, AMDS, application server, and other elements of the systems and processes may be implemented using a combination of hardware and software. In some embodiments, some of the functions and operations described for these elements may be implemented by a common server or software module. In some embodiments, various functions and operations of these elements may be implemented by sub-modules or components, or on separate computing devices.

It will be appreciated that the described operations may be implemented in a number of computing devices, including, without limitation, servers, suitably programmed general purpose computers, audio/video encoding and playback devices, set-top television boxes, television broadcast equipment, and mobile devices. The avail metadata encoder and AMDS may be implemented by way of software containing instructions for configuring a processor to carry out the functions and operations described herein. The software instructions may be stored on any suitable non-transitory computer-readable memory, including CDs, RAM, ROM, Flash memory, etc.

It will be understood that the module, routine, process, thread, or other software component implementing the described method/process for configuring a processor to implement the described functions may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

Certain adaptations and modifications of the described embodiments can be made. Therefore, the above discussed embodiments are considered to be illustrative and not restrictive.

What is claimed is:

1. A method for real-time advertisement insertion, the method comprising:
receiving, at an avail metadata encoder, a request associated with a client device, wherein the request identifies a video;
the avail metadata encoder, in response to the request, then
obtaining avail metadata associated with the video, wherein the avail metadata includes information regarding the video and avails defined for the video, and
customizing the avail metadata by adding information to the avail metadata regarding the client device to produce customized avail metadata;
selecting advertisements from a plurality of available advertisements based upon the customized avail metadata and inserting links to the selected advertisements into the customized avail metadata;
requesting and receiving the selected advertisements from an ad asset server using the links; and
splicing the selected advertisements into the video during play of the video.

2. The method claimed in claim 1, wherein the avail metadata comprises a data structure having predefined fields, and wherein the predefined fields include fields for each avail defined for the video.

3. The method claimed in claim 2, wherein the fields for each avail include an avail type field, an avail duration field, and an avail insertion time field.

4. The method claimed in claim 2, wherein the avail metadata further includes a field for subscriber profile data, subscriber usage data, and geographic location data.

5. The method claimed in claim 1, wherein customizing includes obtaining subscriber profile data associated with the client device, and inserting subscriber profile data in the avail metadata.

6. The method claimed in claim 1, wherein customizing include querying the client device for data regarding the client device, and receiving a response from the client device containing information regarding characteristics of the client device.

7. The method claimed in claim 1, wherein obtaining the avail metadata includes creating the avail metadata using information regarding the video.

8. The method claimed in claim 1, further comprising an initial operation of receiving, at the client device through a user interface, an instruction to play the video, and in response thereto generating the request to the avail metadata encoder.

9. The method claimed in claim 8, wherein the video is stored in memory on the client device.

10. A system for real-time advertisement insertion, the system comprising
an avail metadata encoder having a memory, a processor, and an application executable by the processor that configures the processor to receive a request associated with a client device, wherein the request identifies a video, and in response to
obtain avail metadata associated with the video, wherein the avail metadata includes information regarding the video and avails defined for the video, and
customize the avail metadata by adding information to the avail metadata regarding the client device to produce customized avail metadata; and
an advertising management and decision server configured to select advertisements from a plurality of available advertisements based upon the customized avail metadata and to insert links to the selected advertisements into the customized avail metadata,
whereby selected advertisements are obtained from an ad asset server using the links, and the selected advertisements inserted into the video during play of the video.

11. The system claimed in claim 10, further comprising the client device, wherein the client device includes a user interface, memory, and a microprocessor configured to receive the customized avail metadata, to request the selected advertisements from the ad asset server using on the links, to receive the selected advertisements from the ad asset server, and to insert the selected advertisements into the video.

12. The system claimed in claim 11, wherein the client device is further configured to receive through the user interface an instruction to play the video, and in response thereto to generate the request to the avail metadata encoder.

13. The system claimed in claim 12, wherein the video is stored in memory on the client device.

14. The system claimed in claim 10, wherein the avail metadata comprises a data structure having predefined fields, and wherein the predefined fields include fields for each avail defined for the video.

15. The system claimed in claim 14, wherein the fields for each avail include an avail type field, an avail duration field, and an avail insertion time field.

16. The system claimed in claim 14, wherein the avail metadata further includes a field for subscriber profile data, subscriber usage data, and geographic location data.

17. The system claimed in claim 10, further comprising a subscriber profile database, and wherein the avail metadata encoder is further configured to customize by obtaining subscriber profile data associated with the client device from the subscriber profile database, and inserting the subscriber profile data in the avail metadata.

18. The system claimed in claim 10, wherein the avail metadata encoder is further configured to customize by querying the client device for data regarding the client device, and to receive a response from the client device containing information regarding characteristics of the client device.

19. The system claimed in claim 10, wherein the avail metadata encoder is further configured to obtain the avail metadata by creating the avail metadata using information regarding the video.

20. The system claimed in claim 19, wherein the avail metadata encoder includes a scene-change detection module, and wherein the avail metadata encoder is configured to create the avail metadata by identifying candidate avails using the scene-change detection module, and filtering the candidate avails to a set of selected avails, and producing basic avail metadata specifying the selected avails.
